(19) United States
(12) Patent Application Publication
(10) Pub. No.: US 2013/0114978 A1
(43) Pub. Date: May 9, 2013

(54) CHARGING MEMBER, ELECTROPHOTOGRAPHIC IMAGE FORMING APPARATUS AND ELECTROPHOTOGRAPHIC IMAGE FORMING PROCESS

(71) Applicant: CANON KABUSHIKI KAISHA, Tokyo (JP)

(72) Inventors: Yoshinobu Okumura, Machida-shi (JP); Masaki Sunaga, Atsugi-shi (JP); Yuichi Hashimoto, Tokyo (JP)

(73) Assignee: CANON KABUSHIKI KAISHA, Tokyo (JP)

(21) Appl. No.: 13/670,861

(22) Filed: Nov. 7, 2012

(30) Foreign Application Priority Data
Nov. 9, 2011 (JP) 2011-245993
Nov. 5, 2012 (JP) 2012-243559

(51) Int. Cl. G03G 15/02; B32B 5/16; B82Y 99/00

(52) U.S. Cl. 399/174; 428/292.1; 977/742; 977/932

(57) ABSTRACT

To provide a charging member showing a high charge injection efficiency, the charging member has an electro-conductive substrate and electro-conductive fibers one ends of which stand bonded to the electro-conductive substrate, and the electro-conductive fibers each have a core portion composed of a thermoplastic resin and a sheath portion with which the core portion stands covered, where the sheath portion contains a thermoplastic resin and a plurality of carbon nanotubes standing entangled one another, and the carbon nanotubes stand exposed to the surface of the electro-conductive fibers each at their tip portions.

### BACKGROUND OF THE INVENTION

1. Field of the Invention

The present invention relates to a charging member, an electrophotographic image forming apparatus and an electrophotographic image forming process.

2. Description of the Related Art

As charging systems (charging mechanism or the principle of charging) for the contact charging in electrophotographic image forming apparatus, two types of charging systems are known which are (1) a discharge charging system and (2) a direct injection charging system.

The direct injection charging system is a system in which electric charges are directly injected from a contact charging member into an electrically chargeable body such as an electrophotographic photosensitive member, whereby the surface of the electrically chargeable body is electrostatically charged. A charging assembly making use of a charging brush serving as the contact charging member is structurally simple and also more advantageous in view of cost than a roller charging method making use of a charging roller, and hence it is being put into practical use.

In the charging effected by the charging brush, brush hair of the charging brush, formed of electro-conductive fibers, must be brought into uniform contact with the surface of the electrophotographic photosensitive member. Hence, as the electro-conductive fibers, electro-conductive fibers are used which are obtained by, e.g., dispersing an electro-conductive filler such as carbon in a base material resin such as nylon-6, nylon-66, nylon-12, polyethylene or polypropylene.

Such electro-conductive fibers are produced by, e.g., a method in which resin compound pellets having been so adjusted as to be desirably composed of the base material resin and the electro-conductive filler are kneaded and melted by means of, e.g., an extruder, and the melt-kneaded product obtained is extruded therefrom through spinning nozzles, followed by cooling and stretching.

However, such electro-conductive fibers are usually not more than several percent in a proportion where the electro-conductive filler is distributed on the fiber surfaces. That is, on almost all surfaces of the electro-conductive fibers, an insulating base material resin stands exposed to the surfaces. The injection of electric charges into the electrically chargeable body from tip portions of the electro-conductive fibers is effected only from the electro-conductive filler present at the surfaces of the electro-conductive fibers, which filler is kept in direct contact with the electrically chargeable body. In other words, the electric charges are not injected from base material resin portions where any electro-conductive filler is not present. Hence, in the direct injection charging to the electrically chargeable body by means of the charging brush formed of such electro-conductive fibers on the major part of the surfaces of which an insulating resin stands exposed to the surfaces, there can be said to be still large room for improvement in respect of the efficiency of injection of electric charges.

In Japanese Patent No. 4119072, a charging brush is proposed in which carbon nanotubes are retained only in outermost layers of electro-conductive fibers and one end portions of carbon nanotubes protrude outward from the electro-conductive fibers, and it is stated therein that this enables uniform charging to the surface of the electrophotographic photosensitive member.

Japanese Patent Application Laid-open No. 2007-34196 also discloses that, in a charging member, electro-conductive fibers are used in which carbon nanotubes as an electro-conductive filler dispersed in a base material resin are kept directed substantially equally to the lengthwise direction of the fibers, and this can make the electro-conductive fibers less non-uniform in their resistance value.

In Japanese Patent Application Laid-open No. H11-65227 as well, electro-conductive fibers and a charging brush formed of the same are proposed which former consists of cores composed of a thermoplastic polymer and sheaths composed of a thermoplastic polymer mixed with electro-conductive fine particles, and it is stated therein that this enables uniform charging to the surface of the electrophotographic photosensitive member.

However, according to studies made by the present inventors, it is expected that, taking account of the conditions for injection charging that are to be set down hereafter to make higher in speed and higher in image quality as desired for electrophotographic image forming apparatus, the charging brushes disclosed in the above publications are expected to be difficult to provide the surface of the electrophotographic photosensitive member with sufficient charge potential, for the reasons stated below.

The charging member disclosed in Japanese Patent No. 4119072 is proposed as a charging brush in which carbon nanotubes are retained only in outermost layers of electro-conductive fibers and one end portions of carbon nanotubes protrude outward from the electro-conductive fibers. However, as long as the carbon nanotubes are in such a state that some portions in their lengthwise directions are made to protrude from the fiber surfaces, it is difficult for electric charges to be injected from the whole surfaces of tip portions of the electro-conductive fibers kept in contact with the electrophotographic photosensitive member surface, and it can not be expected to improve the charge injection efficiency especially at the time of high-speed injection charging.

In addition, in the case of such electro-conductive fibers only in the outermost layers of which the carbon nanotubes are retained, it is necessary to make electro-conductive fibers containing an electro-conductive filler other than the carbon nanotubes, making it difficult to make fibers that can simultaneously satisfy the fiber diameter-smallness and desired fiber electric resistance of the fibers.

In the electro-conductive fibers disclosed in Japanese Patent Application Laid-open No. 2007-34196, the carbon nanotubes dispersed in a base material resin are kept directed substantially equally to the lengthwise direction of the fibers. Hence, it follows that, when electric charges are injected into the electrophotographic photosensitive member, highly resistant skin layers present at the surfaces of the electro-conductive fibers come into contact with the electrophotographic photosensitive member. Accordingly, the electric charges are little charged thereinto from the sides of the electro-conductive fibers, and any highly efficient charge injection can not be expected.

Further, in the charging brush disclosed in Japanese Patent Application Laid-open No. H11-65227, electro-conductive fibers are proposed which consist of cores composed of a thermoplastic polymer and sheaths composed of a thermoplastic polymer mixed with electro-conductive fine particles. However, skin layers are present at the surfaces of the electro-conductive fibers, i.e., the surfaces of the sheaths, and hence the charging brush making use of the same is expected to have a poor charging efficiency. In addition, in such fibers with a core-sheath structure in which the sheaths composed of what is mixed with electro-conductive fine particles wrap up a non-electro-conductive component completely, the sheaths must be incorporated with tens of % by mass or more of electro-conductive fine particles such as carbon black in order to make electro-conductive fibers having an electrical resistance value that enables uniform charging. Hence, it is difficult to make such electro-conductive fibers or, even if possible, it is considered that the mechanical properties of such electro-conductive fibers may deteriorate.

### SUMMARY OF THE INVENTION

Accordingly, the present invention is directed to providing a charging member showing a high charge injection efficiency. The present invention is also directed to providing an electrophotographic image forming apparatus that can form high-grade electrophotographic images. Further, the present invention is directed to providing an electrophotographic image forming process that contributes to the formation of high-grade electrophotographic images.

According to an aspect of the present invention, there is provided a charging member comprising an electro-conductive substrate and electro-conductive fibers one ends of which stand bonded to the electro-conductive substrate; the electro-conductive fibers each having a core portion composed of a thermoplastic resin and a sheath portion with which the core portion stands covered; the sheath portion containing a thermoplastic resin and a plurality of carbon nanotubes standing entangled one another, and the carbon nanotubes standing exposed to the surface of the electro-conductive fibers each at their tip portions.

According to another aspect of the present invention, there is provided an electrophotographic image forming apparatus comprising the above charging member and an electrophotographic photosensitive member which is so disposed that the tip portions of the electro-conductive fibers of the charging member come into contact therewith.

According to a further aspect of the present invention, there is provided an electrophotographic image forming process comprising the steps of: applying a charging bias across the above charging member and an electrophotographic photosensitive member to form conducting paths across tip portions of electro-conductive fibers of the charging member and the electrophotographic photosensitive member to thereby charge the electrophotographic photosensitive member electrostatically; exposing to light the surface of the electrophotographic photosensitive member thus charged, to form an electrostatic latent image thereon; and developing the electrostatic latent image.

According to an aspect of the present invention, a charging member can be obtained which shows a high charge injection efficiency. According to another aspect of the present invention, an electrophotographic image forming apparatus can be obtained which can form high-grade electrophotographic images. According to a further aspect of the present invention, an electrophotographic image forming process can be obtained which contributes to the formation of high-grade electrophotographic images.

Further features of the present invention will become apparent from the following description of exemplary embodiments with reference to the attached drawings.

### BRIEF DESCRIPTION OF THE DRAWINGS

FIG. 1 is a schematic view of the charging member according to the present invention.

FIG. 2 is a schematic view of a section of a ribbon-shaped fabric used in the present invention.

FIG. 3 is a diagrammatic view showing the state of dispersion (distribution) of carbon nanotubes present at a section of each tip portion of electro-conductive fibers according to Examples 1 and 2, in its diameter direction.

FIGS. 4A and 4B are views showing electro-conductive fibers according to Example 5. FIG. 4A is a sectional view of each tip portion of the electro-conductive fibers, in its diameter direction. FIG. 4B is a perspective view of each tip portion of the electro-conductive fibers.

FIG. 5 is a sectional view of each fiber of electro-conductive fibers according to Example 3, in its diameter direction.

FIG. 6 is a sectional view of each tip portion of electro-conductive fibers according to Comparative Example 1, in its diameter direction.

FIG. 7 is a schematic view of the electrophotographic image forming apparatus according to the present invention.

FIGS. 8A, 8B and 8C are views showing each fiber of the electro-conductive fibers according to the present invention, in its diameter direction. FIG. 8A is a sectional view of each fiber on the substrate side, in its diameter direction. FIGS. 8B and 8C are sectional views of each tip portion in its diameter direction.

FIG. 9 is an illustration of a scanning probe microscope used in the evaluation of electro-conductive fibers.

FIGS. 10A and 10B are illustrations of core-sheath composite nozzles used in the spinning of the electro-conductive fibers according to the present invention. FIG. 10A is a plan view of the core-sheath composite nozzles. FIG. 10B is a sectional view of one nozzle of the core-sheath composite nozzles.

### DESCRIPTION OF THE EMBODIMENTS

Preferred embodiments of the electro-conductive fibers according to the present invention will now be described in detail with reference to the accompanying drawings.

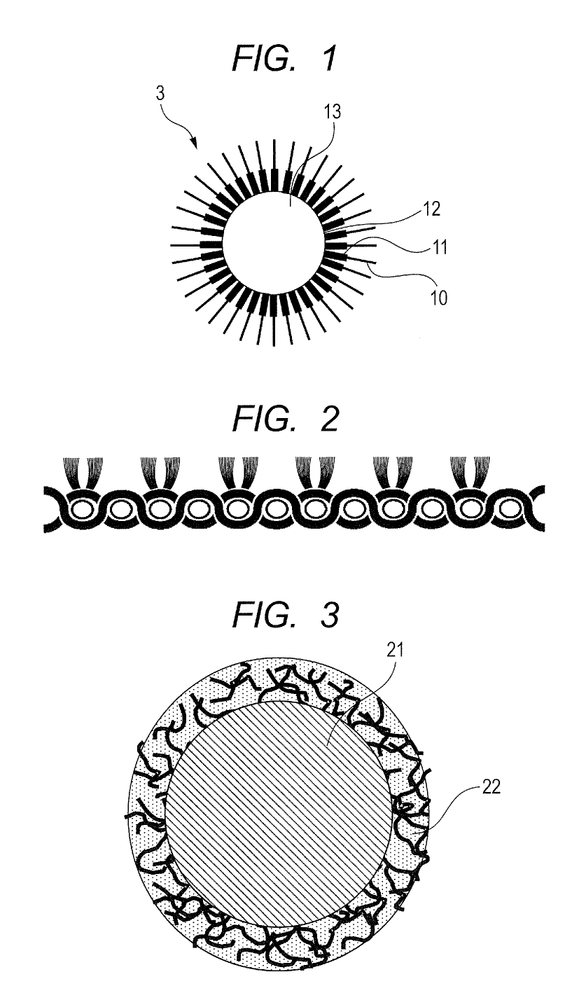

FIG. 1 diagrammatically shows a section of a charging brush 3 illustrating an embodiment of the charging member according to the present invention. In the charging brush 3, electro-conductive fibers 11 are bonded to the surface of a substrate 13 through an electro-conductive adhesive layer 12.

FIGS. 8A, 8B and 8C are each a sectional view of one fiber of the electro-conductive fibers 11, in its diameter direction. FIG. 8A shows a section thereof on the side adjacent to the substrate, in its diameter direction and FIG. 8B and 8C show sections of each tip portion which is to come into contact with the electrophotographic photosensitive member surface, in its diameter direction.

In FIG. 8A, reference numeral 21 denotes a core portion composed of a resin 122. Then, the core portion 21 is covered with a sheath portion 22. The sheath portion 22 is so constituted that it contains carbon nanotubes 121 and a resin 122 as a base material (base material resin 122) and also the carbon nanotubes 121 stand entangled one another therein. Also, the sheath portion 22 is covered with an outermost layer 23 containing a thermoplastic resin.

On the other hand, as shown in FIGS. 8B and 8C, the outermost layer 23 is not present at the tip portion of each electro-conductive fiber 11, i.e., the part shown by reference numeral 10 in FIG. 1. Then, the tip portion 10 of each electro-conductive fiber 11 is, as shown in FIG. 8B for example, constituted of the core portion 21 and the sheath portion 22, which latter is so constituted that it covers the core portion 21 and the carbon nanotubes 121 stand entangled one another.

As another choice, the tip portion 10 is, as shown in FIG. 8C, constituted of the core portion 21, a first sheath portion 22 which is so constituted that it covers the core portion 21 and the carbon nanotubes 121 stand entangled one another in the base material resin, and a second sheath portion 24 which is so constituted that it covers the first sheath portion 22 and the carbon nanotubes 121 stand entangled one another. Here, both the first sheath portion 22 and the second sheath portion 24 are so constituted that a plurality of carbon nanotubes stand entangled one another therein.

As shown in FIG. 8B or 8C, the carbon nanotubes standing entangled one another are exposed to the surface of each electro-conductive fiber 11 at its tip portion 10, and it is considered that a large number of discharge points are present there which can form conducting paths upon contact with the electrophotographic photosensitive member.

The carbon nanotubes being a constituent of the sheath portion 22 may preferably each have a length L of from 1 μm or more to 5 μm or less, and an aspect ratio L/D, which is the ratio of the length L to diameter D, of from 150 or more to 400 or less. Inasmuch as the carbon nanotubes each have a length L of 5 μm or less and an aspect ratio L/D of 400 or less, the carbon nanotubes can be kept from coming oriented in the direction of spinning of fibers even when the electro-conductive fibers are formed by melt spinning, thus the carbon nanotubes in the sheath portion can be made better entangled one another.

The carbon nanotubes may include as specific examples thereof single-walled carbon nanotubes, which are cylindrical tubes formed of a single sheet of grapheme; and multi-walled carbon nanotubes, which are multi-layered cylindrical tubes formed of two or more sheets of grapheme different in diameter.

The thermoplastic resin to be contained in the core portion 21, sheath portion 22 and outermost layer 23 of the electro-conductive fibers each may include, e.g., nylon-6, nylon-66, nylon-12, polyethylene, polypropylene, polyethylene terephthalate, polytrimethylene terephthalate, polybutylene terephthalate, polyphenylene sulfide, and polyether ether ketone. It may also be a mixed resin composed of two or more types of resins.

The electro-conductive fibers according to the present invention may be produced by melt spinning, using for the core portion 21 pellets of the above thermoplastic resin and for the sheath portion 22 pellets of a resin compound prepared by dispersing the carbon nanotubes in the above thermoplastic resin, and using core-sheath composite nozzles. The pellets of a resin compound used as a material for the sheath portion may be produced, for example, by the following method: Base material resin pellets are freeze-pulverized to obtain a fine base material resin powder with a desired particle size distribution, and the fine base material resin powder is mixed with carbon nanotubes. The mixture is then kneaded and melted by means of, e.g., a twin-screw extruder, followed by pelletizing the resultant melt-kneaded product.

As a method for producing the electro-conductive fibers by melt spinning, the electro-conductive fibers are formed by extruding through composite nozzles shown in FIGS. 10A and 10B a molten product of the thermoplastic resin constituting each core portion and a molten product of a resin mixture for forming each sheath portion, containing the thermoplastic resin and the carbon nanotubes. As core-sheath composite nozzles 4, FIG. 10A is a plan view of the composite nozzles and FIG. 10B is a sectional view of one nozzle.

As shown in FIGS. 10A and 10B, the composite nozzles have a structure wherein a spinneret (nozzle plate) 401 and a distributing plate 402 are laminated; the former having circularly arranged 36 round holes which are taperingly made therein and the latter being disposed on the top surface of the spinneret and having distributing holes which correspond to the round holes of the spinneret and are taperingly made therein. A smaller-diameter pipe 403 is inserted into each of the distributing holes, through which pipe a molten product 404 of the thermoplastic resin for forming the core portion is flowed, where, through the space outside this pipe 403, a molten product 405 is flowed which is that of the resin mixture for forming the sheath portion, containing the thermoplastic resin and the carbon nanotubes. Thus, molten fibers with core-sheath structure in which the periphery of the molten product 404 is surrounded by the molten product 405 are forced out through round spinning outlets 406 of the spinneret 401.

The molten fibers forced out through round spinning outlets are subsequently put to a cooling step, thus, electro-conductive fibers are formed which each have a triple-layer structure consisting of the core portion composed of the thermoplastic resin, the sheath portion covering the core portion and containing the carbon nanotubes dispersed in the thermoplastic resin and further the outermost layer covering the sheath portion and containing the thermoplastic resin.

The formation of the outermost layer 23 composed of the thermoplastic resin is described below. When the resin in a molten state flows on the internal wall surface of each nozzle of the core-sheath composite nozzles having a plurality of round-hole nozzles, the resin in a molten state flows, at the front thereof, in such a way that it spouts from the center of a section of the nozzle toward the internal wall surface of the nozzle. This is called fountain flow. On this occasion, the resin in a molten state and standing in contact the nozzle internal wall surface is rapidly cooled on the nozzle internal wall surface to form a skin layer (hereinafter also “outermost layer”). Where the resin in a molten state is incorporated therein with a filler containing carbon nanotubes, the skin layer does not come incorporated therein with any filler containing carbon nanotubes, and is formed of only the resin.

Thus, the electro-conductive fibers each having the triple-layer structure consisting of the core portion, the sheath portion covering the periphery of the core portion and the outermost layer covering the outside of the sheath portion are, after the molten fibers have been cooled and thereafter a treating agent has been made to adhere to cooled fibers, taken up (wound up) on a take-up wheel at a take-up rate of from 100 m/min to 10,000 m/min, and preferably from 300 m/min to 2,000 m/min. Here, a fiber(s) forced out of the core-sheath composite nozzles may commonly be a single, monofilament (which is otherwise forced out of one composite nozzle), but may preferably be a multifilament composed of a bundle of a plurality of fibers as in the present case, and the number of fibers in one bundle of fibers may preferably be 20 to 200. Also, the treating agent made to adhere thereto may preferably be a treating agent of a water-containing type or non-water-containing type.

The electro-conductive fibers according to the present invention may be obtained by first forming the electro-conductive fibers having the triple-layer structure, and thereafter, in a state or form described hereinafter, removing the outermost layers present at the tip portions of the fibers to make the sheath portions exposed to the surfaces. Here, in removing the outermost layers, oxygen plasma treatment or alkali aqueous solution treatment may preferably be used, for example.

The oxygen plasma treatment is a process in which oxygen gas is fed into a vacuum container and, keeping it in a vacuum condition, oxygen plasma is caused to take place between inner walls of the vacuum container, serving as an electrode, and a porous metallic cylindrical electrode placed inside the vacuum container to treat the surface of an untreated charging brush placed inside the porous metallic cylindrical electrode. Inasmuch as the untreated charging brush is placed inside the porous metallic cylindrical electrode, ions and electrons in the plasma can be controlled, and this enables removal of the outermost layers present at the surfaces of tip portions of the electro-conductive fibers having the core-sheath structure, constituting the untreated charging brush.

Conditions for generating the plasma are selected as desired, depending on the construction of a vacuum system and the size of a treatment object. As high-frequency power, it may preferably be from 30 W to 500 W, and, as oxygen gas feed rate, from 30 sccm to 200 sccm.

The oxygen plasma treatment may preferably be carried out for a time of from 2 minutes or more to 60 minutes or less to prevent the electro-conductive fibers from excessive heating and to accomplish the sufficient oxygen plasma treatment. Further, when the oxygen plasma treatment is carried out for more than 10 minutes, it is preferable to stop the plasma treatment for few or several minutes at intervals of 10 minutes to lower the temperature of the charging brush surface being treated.

Further, where the thermoplastic resin that constitutes the sheath portions and outermost layers is a polyester such as polyethylene terephthalate, polytrimethylene terephthalate or polybutylene terephthalate, the alkali aqueous solution treatment may preferably be employed.

As the alkali aqueous solution treatment, it is preferable to retain the untreated electro-conductive fibers for tens of minutes to hundreds of minutes in an aqueous few % by mass sodium hydroxide solution or aqueous potassium hydroxide solution kept at 50° C. to 100° C.

Now, in the injection charging, in order to secure the convergence of potential, it is desirable that the time for which the electrophotographic photosensitive member passes a nip where it is in contact with the charging brush is about 5 times or more the time constant consisting of the resistance of the electro-conductive fibers at the peripheral surface of the charging brush member and the electrostatic capacity of the electrophotographic photosensitive member. For example, an amorphous silicon photosensitive member, having a higher dielectric constant than any organic type electrophotographic photosensitive member, is used at a peripheral speed of 200 mm/sec or more in some cases. In such a case, namely, a case in which the time constant is 2 msec (milliseconds) or less, it is preferable that, at the part of contact of the tip portions of the charging brush with the electrophotographic photosensitive member surface, what is called the amount of penetration is hundreds of μm or more, and also preferable that the nip where the charging brush is in contact with the electrophotographic photosensitive member has a certain width in the rotational direction of the photosensitive member.

Hence, in general, what is called the amount of penetration that is the value found by subtracting the distance between the rotating shaft of the electrophotographic photosensitive member and that of the charging member from the total of a radius of the electrophotographic photosensitive member and a radius of the charging member may preferably be 400 μm or more. Accordingly, at the tip portions of the electro-conductive fibers each having the triple-layer core-sheath structure consisting of the core portion composed of the thermoplastic resin, the sheath portion covering the core portion and containing a plurality of carbon nanotubes standing three-dimensionally entangled one another in the thermoplastic resin and further the outermost layer covering the sheath portion and containing the thermoplastic resin, the range in which each sheath portion is exposed to the surface may preferably be 400 μm or more from each tip of the electro-conductive fibers.

The electro-conductive fibers used in the present invention may preferably have an electrical resistance value per fiber, of 1×10³ Ω or more in order to prevent the electrophotographic photosensitive member from causing breakdown due to any current concentration to any part of the electrophotographic photosensitive member. Also, in order to stabilize the charge potential even in an injection charging condition where the time constant comes to be 2 msec or less, the electro-conductive fibers may preferably have an electrical resistance value per fiber, of 1×10¹⁰ Ω or less as occasion calls.

Thus, the electro-conductive fibers of the charging brush may have an electrical resistance value per fiber, of from 1×10³ Ω or more to 1×10¹⁰ Ω or less as a preferable range of selection.

As the substrate of the charging member according to the present invention, an electro-conductive material such as a metal or an alloy may preferably be used. It may also be a substrate obtained by covering an insulator or semiconductor with an electro-conductive metal. Stated specifically, the material may be stainless steel (SUS), Al or an Al alloy, Fe or an Fe alloy, Cu or a Cu alloy, Ni or an Ni alloy, or the like. Instead, it may also be any of the above metal or alloy, provided on its surface with an electro-conductive rubber layer.

The charging brush according to the present invention may specifically include one produced by either of the following two methods.

1) A woven brush produced by spirally winding around an electro-conductive mandrel shaft (substrate) a belt-shaped base fabric obtained by weaving bundles of a plurality of fibers of the electro-conductive fibers made by melt spinning.
2) An electrostatic flock brush produced by what is called electrostatic flocking, in which the electro-conductive fibers made by melt spinning are cut in a length of from about 0.5 mm to about 3 mm and thereafter the cut fibers are so caused to fly by utilizing static electricity as to be bedded in a substrate beforehand provided thereon with an electro-conductive adhesive layer by coating.

The woven brush is produced by a method as shown below. First, a woof-pile-woven base fabric having electro-conductive fibers is obtained which has been produced using as woofs the electro-conductive fibers made by melt spinning. The pile composed of the electro-conductive fibers is so made as to have a length of, e.g., from 0.5 mm to 5 mm. Then, the substrate is coated on its surface with an electro-conductive adhesive in a thickness of from 20 μm to 100 μm by, e.g., spraying. Thereafter, the base fabric and the substrate are joined together by spirally winding the former, with its side down on which the electro-conductive fibers are not raised, around the peripheral surface of the latter having been coated with the electro-conductive adhesive, followed by drying for few hours by means of a 60° C. to 100° C. dryer.

The electrostatic flock brush is produced by a method as shown below. The electro-conductive fibers made by melt spinning are cut in a length of from about 0.5 mm to about 3 mm to obtain cut pile. Next, an electro-conductive adhesive layer is formed on the surface of the substrate. Then, while the substrate thus provided with the electro-conductive adhesive layer is rotated around its axis, an electrode plate is placed beneath it. Next, the cut pile is put on the electrode plate, and the electrode plate and the substrate are connected to a high-voltage power source, thus the cut pile flies to come transplanted onto the electro-conductive adhesive layer on the substrate.

The electro-conductive adhesive layer to be formed on the substrate may be formed by coating the substrate with an electro-conductive adhesive in a thickness of from 50 μm to 200 μm by spraying, followed by heat curing; the electro-conductive adhesive being an adhesive composed of an acrylic type, epoxy type or urethane type resin and an electro-conductive filler dispersed therein.

The electro-conductive adhesive layer used in the present invention may have resistivity in a value of from 1.0×10² Ω·cm or more to 1.0×10⁸ Ω·cm or less as a preferable range.

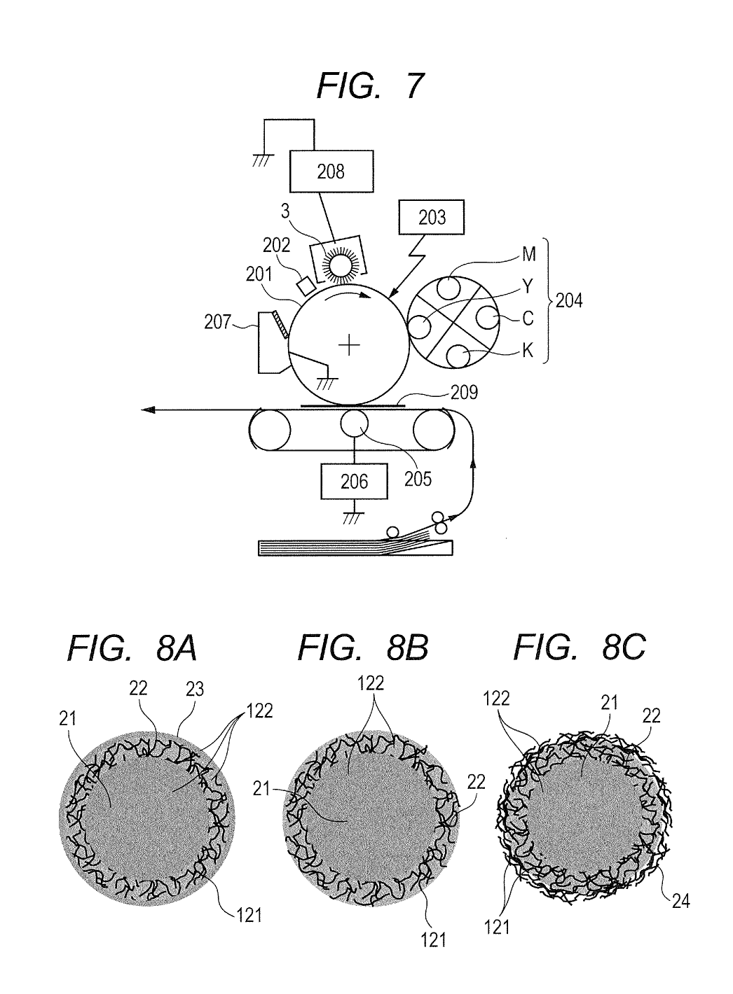

As shown in FIG. 7, an electrophotographic image forming apparatus according to an embodiment of the present invention has a charging member 3 comprised of the charging brush described above, and an electrophotographic photosensitive member (herein also “photosensitive drum”) 201 which is electrostatically charged by this charging member and on which electrostatic latent images are formed. The electrophotographic photosensitive member 201 is so disposed that the surfaces of the electro-conductive fibers of the charging member 3 may come into contact therewith.

As the electrophotographic photosensitive member 201, an a-Si type photosensitive drum having a diameter of 80 mm and being negatively chargeable is used, for example. The photosensitive drum is rotated at a speed of 300 mm/sec. As a pre-exposure lamp 202, an LED of 660 nm in wavelength is used, and the surface of the photosensitive drum is exposed to light in order to uniformly lower the surface potential of the photosensitive drum immediately before its charging.

As a charging assembly, it is one making use of the charging brush 3 having the electro-conductive fibers containing the carbon nanotubes as described above. Then, the carbon nanotubes standing exposed to the surfaces of the electro-conductive fibers at their tip portions and the surface of the photosensitive drum are brought into contact with each other to thereby form conducting paths across the both to charge the surface of the photosensitive drum electrostatically.

Next, scanning exposure is performed by laser light 203 modulated with image signals, so that the electrostatic latent images are formed on the photosensitive drum.

In a developing assembly 204, four-color (M, Y, C, K) developing sleeves internally holding magnet rollers are coated thereon with corresponding developers, where a developing bias voltage is applied thereto by using a developing assembly power source, whereby the electrostatic latent images are developed to form toner images on the photosensitive drum. As the developers, those composed of negatively chargeable toners of about 7 μm each in particle diameter and magnetic particles for development of about 35 μm each in particle diameter are used. The developing sleeves are each rotated in the same direction as the rotation of the photosensitive drum and rotated at a peripheral speed of about 450 mm/sec. The magnet rollers of the developing sleeves which sequentially come to face the photosensitive drum each have magnetic poles with a magnetic field of 90 mT. The gap between each developing sleeve surface and the photosensitive drum surface are set to be 350 μm.

A transfer assembly has an electro-conductive spongy roller 205 of 16 mm in diameter and a direct-current power source 206. A voltage with a polarity reverse to the charge polarity of the toners is applied to the former from the direct-current power source 206, interposing a transfer material 209 between the electro-conductive spongy roller 205 and the photosensitive drum via a transfer material transport belt, whereby toner images are transferred onto the transfer material.

For a cleaner 207, a 2 mm thick cleaning blade made of urethane is used, and cleaning is performed by scraping transfer residual toners off the surface of the photosensitive drum with the cleaning blade.

The charging brush fitted to the charging assembly used in the present invention has an outer diameter of 20 mm, and is so disposed on the photosensitive drum that their rotating shafts are in parallel. What is called the amount of penetration that is the value found by subtracting the distance between the respective rotating shafts from the value found by adding a radius of the photosensitive drum and a radius of the charging brush is set to be 750 μm. The rotational direction of the charging brush is set to be the same as that of the photosensitive drum, where they move to the directions opposite to each other at the zone of contact between the photosensitive drum surface and the charging brush surface, and the rotational speed of the charging brush is set to be from 450 mm/sec to 900 mm/sec.

As a bias for charging, a direct-current voltage of −700 V is applied from a power source 208. In Examples, only direct-current voltage is used, but an alternating-current voltage such as sinusoidal-current voltage may be superimposed thereon.

Image formation is performed by using the electrophotographic image forming apparatus to which the charging brush of the present invention is mounted as described above, and this enables good image reproduction.

As having been described in the foregoing, the charging brush according to the present invention contains the carbon nanotubes standing entangled one another and also such carbon nanotubes stand exposed to the surfaces of the electro-conductive fibers at their tip portions. Hence, the resistance of contact between the surface of the electrophotographic photosensitive member and the fiber tip portions of the charging member can be lessened, and also the electric charges can be injected at a high efficiency.

### EXAMPLES

Examples of the present invention are given below, to which, however, the present invention is by no means limited.

### Example 1

Polyethylene terephthalate pellets of 0.8 in intrinsic viscosity (hereinafter simply “IV” value), 3 mm in diameter and 5 mm in length were freeze-pulverized, followed by classification to obtain a fine polyethylene terephthalate powder of 20 μm or less in particle diameter. Next, the fine polyethylene terephthalate powder of 20 μm or less in particle diameter and carbon nanotubes of 5 μm or less in length, 3 μm in average length, 400 or less in aspect ratio and 200 in average aspect ratio were so dry-blended that the carbon nanotubes were in a content of 5% by mass, followed by kneading and melting by means of a twin-screw extruder, and then pelletizing the melt-kneaded product to prepare pellets of a polyethylene terephthalate resin compound in which the carbon nanotubes were uniformly dispersed.

Next, the above pellets of the resin compound polyethylene terephthalate in which the carbon nanotubes were uniformly dispersed and other polyethylene terephthalate pellets of 0.95 in IV were dried at 140° C. for 4 hours.

Next, the pellets of the polyethylene terephthalate resin compound in which the carbon nanotubes were uniformly dispersed, used as a material for forming sheath portions, and the polyethylene terephthalate pellets of 0.95 in IV, used as a material for forming core portions, were respectively separately fed into two twin-screw extruders. The two kinds of pellets were then guided to core-sheath composite nozzles (see FIGS. 10A and 10B) having a spinneret of 0.3 mm in nozzle diameter and 36 in number of round holes, where the molten products of the respective pellets were ejected from the nozzles to carry out spinning at a spinning temperature of 290° C., in such a way that the sectional area of each core portion to that of each sheath portion were in a ratio of 5:5.

The filaments thus spun out were, while they were cooled and solidified by means of a cooling unit (a uniflow type) of 1 m in cooling length and by blowing a cooling wind of 25° C. in wind temperature and 0.5 m/second in wind velocity, taken up (wound up) on a take-up wheel at a wind-up speed of 1,000 m/second through a converging means to prepare an unstretched multifilament yarn composed of electro-conductive fibers of 38 μm in fiber diameter. Incidentally, in the course of being cooled and solidified, a lubricant (effective component: 10% by mass in concentration) was made to adhere to the filaments spun out. Subsequently, the unstretched multifilament yarn thus obtained was so hot-stretched at a temperature of 150° C. as to come to be twice as stretch ratio to prepare a stretched multifilament yarn which was composed of 36 electro-conductive fibers of 24 μm in fiber diameter.

From the multifilament yarn thus prepared, one fiber of the electro-conductive fibers was pulled out, and its surface and section were observed by SEM. As the result, the electro-conductive fiber was found to have a triple-layer core-sheath structure consisting of a core portion composed of the polyethylene terephthalate resin, a sheath portion covering the core portion and containing carbon nanotubes standing entangled one another in the polyethylene terephthalate resin and further an outermost layer covering the sheath portion and containing the polyethylene terephthalate resin.

Next, using the above multifilament yarn having been subjected to hot stretching treatment, composed of 36 electro-conductive fibers each having the triple-layer core-sheath structure, a ribbon-shaped pile fabric of 15 mm in width was made which was as shown in FIG. 2. The ribbon-shaped pile fabric was wound around an aluminum pipe, in the state of which (i.e., in the same state as that of a charging brush) the oxygen plasma treatment described previously was carried out at frequency of 13.56 MHz, supplied electric power of 350 W, oxygen gas feed rate of 150 sccm for 15 minutes, placing the fabric-wound aluminum pipe in the porous metallic cylindrical electrode set inside the vacuum container in the state only the both end portions of the aluminum pipe were supported.

One fiber of the electro-conductive fibers was pulled out from the ribbon-shaped pile fabric having been subjected to the oxygen plasma treatment, and the surface and section of the electro-conductive fiber at its tip portion on the side subjected to the oxygen plasma treatment were observed by SEM. From the result of the observation by SEM, it was found that, as shown in FIG. 3, the outermost layer containing the polyethylene terephthalate resin, having covered the sheath portion, was removed and further that, in the sheath portion at the fiber surface, a network structure was made up in which the carbon nanotubes stood entangled one another on the surface, and in the interior, of the sheath portion. The carbon nanotubes stood entangled one another also stood exposed to the surface of the tip portion of the electro-conductive fiber. Here, this electro-conductive fiber had an electrical resistance value per fiber, of 8×10⁷ Ω.

### Example 2

An unstretched multifilament yarn composed of electro-conductive fibers of 38 μm in fiber diameter was prepared by the same melt spinning as Example 1 except that the carbon nanotubes of the sheath portions were in a content of 4% by mass. Next, this was subjected to hot stretching treatment under the same conditions as Example 1 to make a multifilament yarn which was composed of 36 fibers electro-conductive fibers of 24 μm in fiber diameter each having core-sheath structure.

Next, using the above multifilament yarn having been subjected to hot stretching treatment, composed of 36 electro-conductive fibers each having the triple-layer core-sheath structure, a ribbon-shaped pile fabric of 15 mm in width was made which was as shown in FIG. 2. This ribbon-shaped pile fabric was subjected to alkali aqueous solution treatment. To carry out the alkali aqueous solution treatment, the whole surfaces of the tip portions of the electro-conductive fibers constituting the ribbon-shaped pile fabric were immersed in an aqueous sodium hydroxide solution having a concentration of 3% by mass and kept at a temperature of 65° C., retaining this for 240 minutes with gentle stirring. After the treatment, the treated pile fabric was thoroughly washed with water, followed by drying at 70° C. for 90 minutes.

After the drying, one fiber of the electro-conductive fibers was pulled out from the ribbon-shaped pile fabric, and the surface and section of the electro-conductive fiber at its tip portion which had been immersed in the aqueous sodium hydroxide solution were observed by SEM. As the result, it was found that, as shown in FIG. 3, the outermost layer containing the polyethylene terephthalate resin, having covered the sheath portion 22, was removed and also that, in the sheath portion 22 covering the core portion 21, the carbon nanotubes stood three-dimensionally entangled one another in the base material resin and the carbon nanotubes standing three-dimensionally entangled one another also stood exposed to the surface of the sheath portion 22. Here, the electro-conductive fiber had an electrical resistance value per fiber, of 1×10⁶ Ω.

### Example 3

Polyphenylene sulfide pellets of 10 Pa·s in melt viscosity, 3 mm in diameter and 5 mm in length were freeze-pulverized, followed by classification to prepare a fine polyphenylene sulfide powder of 100 μm or less in particle diameter and 60 μm in average particle diameter. The melt viscosity is the value measured under conditions of 310° C. and a shear rate of 1,000/second by using a capillary rheometer.

Next, the above-mentioned fine polyphenylene sulfide powder and carbon nanotubes of 5 μm or less in length, 3 μm in average length, 400 or less in aspect ratio and 200 in average aspect ratio were so dry-blended that the carbon nanotubes were in a content of 6% by mass, followed by kneading and melting by means of a twin-screw extruder, and then pelletizing the melt-kneaded product by a known method to prepare pellets of a polyphenylene sulfide resin compound in which the carbon nanotubes were uniformly dispersed.

Next, in such a way that the above pellets of a polyphenylene sulfide resin compound in which the carbon nanotubes were uniformly dispersed might come to be sheath portions and other polyphenylene sulfide pellets of 40 Pa·s in melt viscosity might come to be core portions, otherwise the same melt spinning as Example 1 was carried out to prepare an unstretched multifilament yarn of 8:2 in core portion to sheath portion sectional area ratio and composed of electro-conductive fibers of 42 μm in fiber diameter. Then, hot stretching treatment was carried out under the same conditions as Example 1 to make a multifilament yarn which was composed of 36 fibers electro-conductive fibers of 29 μm in fiber diameter each having core-sheath structure.

From the multifilament yarn composed of 36 electro-conductive fibers, one fiber of the electro-conductive fibers was pulled out, and its surface and section were observed by SEM. As the result, the electro-conductive fiber was found to have a triple-layer core-sheath structure consisting of a core portion composed of the polyphenylene sulfide resin, a sheath portion covering the core portion and containing carbon nanotubes standing entangled one another in the polyphenylene sulfide resin and further an outermost layer covering the sheath portion and containing the polyphenylene sulfide resin.

Next, using the above multifilament yarn having been subjected to hot stretching treatment, composed of 36 electro-conductive fibers each having the triple-layer core-sheath structure, a ribbon-shaped pile fabric of 15 mm in width was made which was as shown in FIG. 2, and thereafter oxygen plasma treatment was carried out.

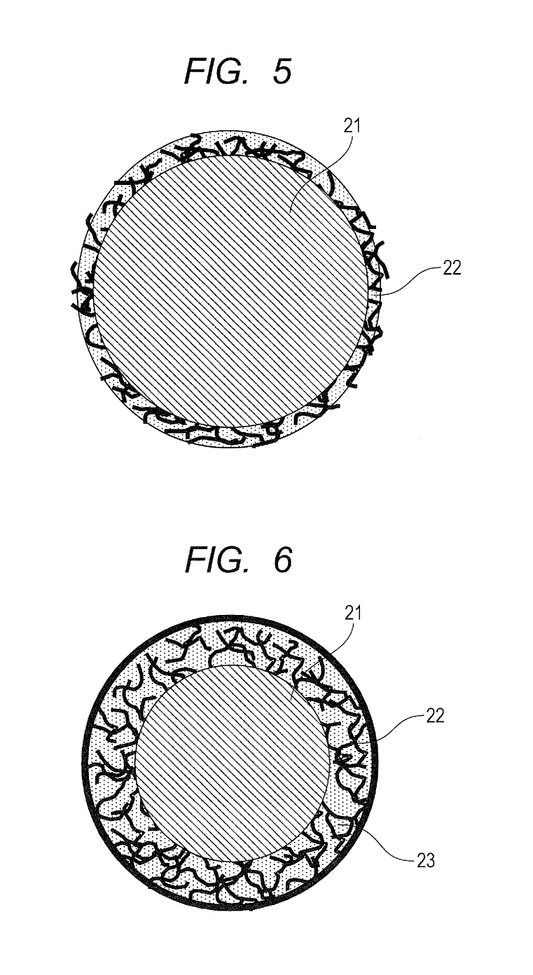

One fiber of the electro-conductive fibers was pulled out from the ribbon-shaped pile fabric having been subjected to the oxygen plasma treatment, and the surface and section of the electro-conductive fiber at its tip portion on the side subjected to the oxygen plasma treatment were observed by SEM. From the result of the observation by SEM, it was found that, as shown in FIG. 5, the outermost layer containing the polyphenylene sulfide resin, having covered the sheath portion, was removed and further that, in the sheath portion at the fiber surface, a network structure was made up in which the carbon nanotubes stood entangled one another on the surface, and in the interior, of the sheath portion. It was also ascertainable that the carbon nanotubes standing entangled one another stood exposed to the surface of the tip portion of the electro-conductive fiber. Here, this electro-conductive fiber had an electrical resistance value per fiber, of 2×10⁷ Ω.

### Comparative Example 1

As in Example 1, from the multifilament yarn having been hot-stretched and composed of 36 electro-conductive fibers of 24 μm in fiber diameter, having the core-sheath structure, one fiber of the electro-conductive fibers was pulled out and its surface and section were observed by SEM. From the result of the observation by SEM, the fiber was found to have, as diagrammatically shown in FIG. 6, a triple-layer core-sheath structure consisting of a core portion composed of the polyethylene terephthalate resin, a sheath portion covering the core portion and containing carbon nanotubes in the polyethylene terephthalate resin and further an outermost layer covering the sheath portion and containing the polyethylene terephthalate resin. Also, the carbon nanotubes were found to stand entangled one another inside the sheath portion, but scarcely any carbon nanotubes were found to be present on the outside of the sheath portion, i.e., in the outermost layer of the fiber. Also, this electro-conductive fiber had an electrical resistance value per fiber, of 3×10¹¹ Ω.

### Comparative Example 2

An unstretched multifilament yarn was prepared by melt spinning in the same way as Example 1 except that carbon nanotubes of 2 μm in average length and 650 in average aspect ratio were used as the carbon nanotubes. The unstretched multifilament yarn obtained was so hot-stretched at 150° C. as to come to be twice as stretch ratio, whereupon the fibers came cut in the course of stretching to make it unable to obtain any electro-conductive fibers.

### Comparative Example 3

An unstretched multifilament yarn was prepared by melt spinning in the same way as Example 1 except that, in preparing in Example 1 the pellets of the polyethylene terephthalate resin compound in which the carbon nanotubes were dispersed, polyethylene terephthalate pellets of 3 mm in diameter and 5 mm in length and carbon nanotubes of 5 μm or less in length, 3 μm in average length, 400 or less in aspect ratio and 200 in average aspect ratio were directly dry-blended. The unstretched multifilament yarn obtained was so hot-stretched at 150° C. as to come to be twice as stretch ratio, whereupon the fibers came cut in the course of stretching to make it unable to obtain any electro-conductive fibers.

### Example 4

A multifilament yarn composed of 36 fibers electro-conductive fibers of 24 μm in fiber diameter was made in the same way as Example 1.

Next, using the multifilament yarn composed of 36 electro-conductive fibers, a ribbon-shaped pile fabric of 15 mm in width was made which was as shown in FIG. 2. The ribbon-shaped pile fabric was wound around a cylindrical SUS stainless steel substrate, in the state of which oxygen plasma treatment was carried out in the same way as Example 1. After the oxygen plasma treatment, the surface was put to final finish working to obtain a charging brush of 20 mm in outer diameter. The electro-conductive fibers at the surface of this charging brush were in a density of 200 kF/inch².

From this charging brush, one fiber of the electro-conductive fibers was pulled out, and the surface and section of the electro-conductive fiber were observed by SEM. As the result, it was ascertained that, at the tip portion of the electro-conductive fiber, as shown in FIG. 3, the outermost layer containing the polyethylene terephthalate resin, having covered the sheath portion, was removed and further that, in the sheath portion at the fiber surface, a network structure was made up in which the carbon nanotubes stood entangled one another on the surface, and in the interior, of the sheath portion.

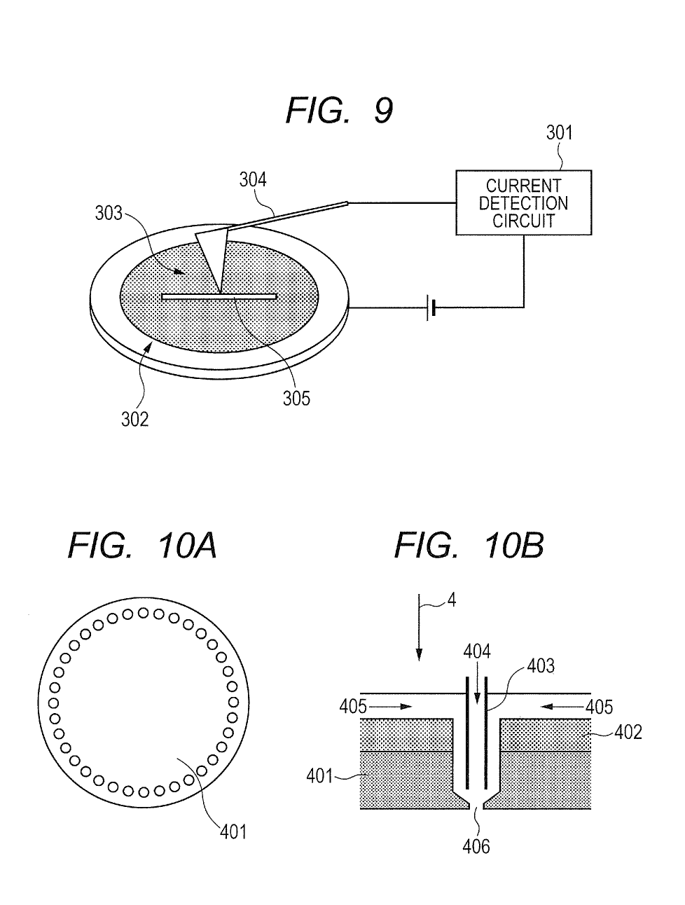

Discharge performance of this electro-conductive fiber at its tip portion and at the surface of the part having been subjected to the oxygen plasma treatment was also evaluated by a method described below. That is, using a scanning probe microscope shown in FIG. 9, a bias voltage of 10 V was applied to an STM (scanning tonneling microscope) probe 304, and this STM probe was brought into touch with the surface of an electro-conductive fiber 305 placed on a well electro-conductive sheet 303 put on a sample rest 302 made of aluminum, where, with scanning performed in an area of 5 μm×5 μm, the value of electric current flowing through the probe was measured in the whole area of scanning ranges. As the result, conducting paths were found to stand formed across electrodes in an area of about 78%, based on the whole surface area of measured portions of the part subjected to the oxygen plasma treatment.

Next, this charging brush was fitted to the electrophotographic image forming apparatus (copying machine) shown in FIG. 7, and the amount of penetration of the charging brush to the photosensitive drum was set to be 750 μm. The rotational speed of the charging brush was set at 800 mm/sec, and a direct-current voltage of −600 V was applied to the charging brush, where electrophotographic images were formed. As the result, good images were obtained, having halftone areas with a uniform halftone dot size. That is, it was ascertainable that the photosensitive drum was able to be uniformly and well charged.

### Example 5

A ribbon-shaped pile fabric of 15 mm in width which was as shown in FIG. 2 was made in the same way as Example 4. Next, this ribbon-shaped pile fabric was subjected to alkali aqueous solution treatment in the same way as Example 2, followed by washing with water and then drying. The ribbon-shaped pile fabric having been dried was wound around a cylindrical SUS stainless steel substrate, and thereafter the surface was put to final finish working to obtain a charging brush of 20 mm in outer diameter. The electro-conductive fibers at the surface of this charging brush were in a density of 200 kF/inch².

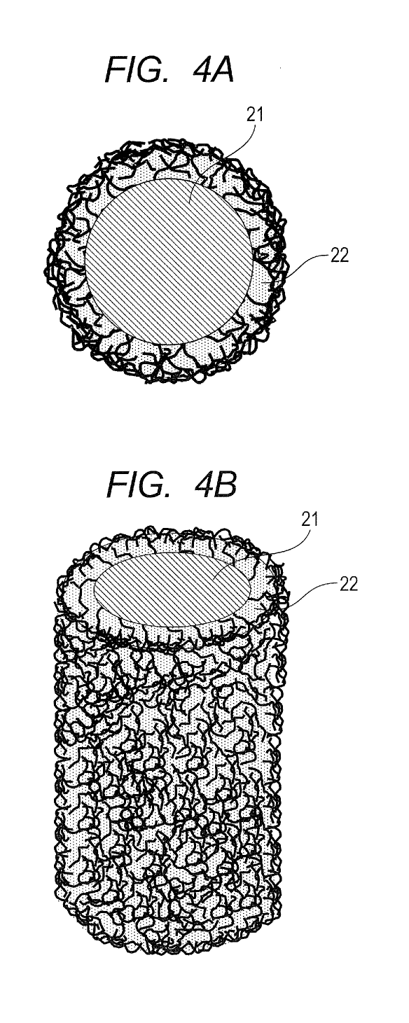

From this charging brush, one fiber of the electro-conductive fibers was pulled out, and the surface and section of the electro-conductive fiber were observed by SEM. As the result, it was ascertained that, at the tip portion of the electro-conductive fiber, as shown in FIGS. 4A and 4B, the outermost layer containing the polyethylene terephthalate resin, having covered the sheath portion, was removed. It was also ascertained that a sheath portion 22 covering a core portion 21 was constituted of a first sheath portion in which carbon nanotubes stand three-dimensionally entangled one another in the base material resin and a second sheath portion 24 covering the first sheath portion 22 and in which carbon nanotubes stand three-dimensionally entangled one another.

Discharge performance of this electro-conductive fiber at its surface was also evaluated by a method described below. That is, using a scanning probe microscope shown in FIG. 9, the value of electric current at the surface of an electro-conductive fiber was measured in the whole area of scanning ranges in the same way as Example 4. As the result, conducting paths were found to stand formed across electrodes in an area of about 95%, based on the whole surface area of measured portions of the part subjected to the alkali aqueous solution treatment.

Next, this charging brush was fitted to the electrophotographic image forming apparatus (copying machine) shown in FIG. 7, and the amount of penetration of the charging brush to the photosensitive drum was set to be 750 μm. The rotational speed of the charging brush was set at 500 mm/sec, and a direct-current voltage of −600 V was applied to the charging brush, where electrophotographic images were formed. As the result, good images were obtained, having halftone areas with a uniform halftone dot size. That is, it was ascertainable that the photosensitive drum was able to be uniformly and well charged.

### Comparative Example 4

In the same way as Example 1, a multifilament yarn composed of 36 fibers electro-conductive fibers was made and then a ribbon-shaped pile fabric of 15 mm in width was made.

Next, this ribbon-shaped pile fabric having been dried was wound around a cylindrical SUS stainless steel substrate, and thereafter, without carrying out any oxygen plasma treatment, the surface was put to final finish working to obtain a charging brush of 20 mm in outer diameter. The electro-conductive fibers at the surface of this charging brush were in a density of 200 kF/inch².

From this charging brush, one fiber of the electro-conductive fibers was pulled out, and the discharge performance of this electro-conductive fiber at its surface was also evaluated by a method described below. That is, in the same way as Example 5, using the scanning probe microscope, the value of electric current at the surface of an electro-conductive fiber was measured in the whole surface area of scanning ranges. As the result, conducting paths were found to stand formed across electrodes in an area of about 32%, based on the whole surface area of measured portions of the electro-conductive fiber.

Next, in the same way as Example 5, this charging brush was fitted to the electrophotographic image forming apparatus (copying machine) shown in FIG. 7, and the amount of penetration of the charging brush to the photosensitive drum was set to be 750 μm. The rotational speed of the charging brush was set at 800 mm/sec, and a direct-current voltage of −600 V was applied to the charging brush, where electrophotographic images were formed. As the result, images were reproduced in which the toner fogged in streaks in the white background area of paper along its feed direction. Also, the images were coarse images as having halftone areas with an irregular halftone dot size.

The charging brush of the present invention can be applied to an image forming apparatus making use of an electrophotographic system. Stated more specifically, this charging brush enables a uniform charge potential to be obtained without use of any discharge charging, for an apparatus in which as an image bearing member an organic photosensitive member or amorphous silicon photosensitive member having a charge injection layer at the surface is electrostatically charged by contact charging, and thereafter a latent image is formed, then a developer image is formed and then the developer image is transferred to a transfer material and fixed thereto to form an image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese

Patent Application No. 2011-245993, filed Nov. 9, 2011, and Japanese Patent Application No. 2012-243559, filed Nov. 5, 2012, which are hereby incorporated by reference herein in their entirety.

What is claimed is:

1. A charging member comprising an electro-conductive substrate and electro-conductive fibers one ends of which stand bonded to the electro-conductive substrate, wherein:
the electro-conductive fibers each has
a core portion composed of a thermoplastic resin and
a sheath portion with which the core portion stands covered;
the sheath portion contains a thermoplastic resin and a plurality of carbon nanotubes standing entangled one another, and wherein:
the carbon nanotubes stand exposed to the surface of the electro-conductive fibers each at their tip portions.

2. The charging member according to claim 1, wherein, in the electro-conductive fibers each;
on their substrate side each, the sheath portion stands covered with an outermost layer containing a thermoplastic resin; and
at their tip portions each, the sheath portion is not covered with the outermost layer and the carbon nanotubes contained in the sheath portion stand exposed to the surface.

3. The charging member according to claim 1, wherein the carbon nanotubes each has a length of from 1 μm or more to 5 μm or less, and each has an aspect ratio of from 150 or more to 400 or less.

4. The charging member according to claim 1, wherein the thermoplastic resin contained in the core portion and sheath portion is a thermoplastic resin selected from the group consisting of nylon-6, nylon-66, nylon-12, polyethylene, polypropylene, polyethylene terephthalate, polytrimethylene terephthalate, polybutylene terephthalate, polyphenylene sulfide, and polyether ether ketone.

5. The charging member according to claim 1, wherein the electro-conductive fibers are fibers made by melt spinning using core-sheath composite nozzles, and obtained by removing skin layers present at tip portions of fibers each having a triple-layer core-sheath structure consisting of a core portion, a sheath portion covering the core portion and a skin layer covering the outside of the sheath portion, to expose to the surface the plurality of carbon nanotubes which the sheath portion contains.

6. The charging member according to claim 1, wherein the electro-conductive fibers have an electrical resistance value per fiber, of from 1×10³ Ω or more to 1×10¹⁰ Ω or less.

7. An electrophotographic image forming apparatus comprising:
the charging member according to claim 1; and
an electrophotographic photosensitive member which is so disposed that tip portions of the electro-conductive fibers of the charging member come into contact therewith.

8. An electrophotographic image forming process comprising the steps of:
applying a charging bias across the charging member according to claim 1 and an electrophotographic photosensitive member to form conducting paths between tip portions of electro-conductive fibers of the charging member and the electrophotographic photosensitive member to thereby charge the electrophotographic photosensitive member electrostatically;
exposing to light the surface of the electrophotographic photosensitive member thus charged, to form an electrostatic latent image thereon; and
developing the electrostatic latent image.
